(19) United States
(12) Patent Application Publication
(10) Pub. No.: US 2007/0067248 A1
(43) Pub. Date: Mar. 22, 2007

(54) METHOD AND SYSTEM FOR VALIDATING AND VERIFYING MAIL ITEMS

(75) Inventor: Fabien Chatte, Nogent Sur Marne (FR)

Correspondence Address: SUGHRUE MION, PLLC, 2100 PENNSYLVANIA AVENUE, N.W., SUITE 800, WASHINGTON, DC, 20037, US

(73) Assignee: NEOPOST Technologies, Bagneux (FR)

(21) Appl. No.: 11/470,861

(22) Filed: Sep. 7, 2006

(30) Foreign Application Priority Data
Sep. 9, 2005 (FR) 0509184

(51) Int. Cl. G06F 17/00

(52) U.S. Cl. 705/401

(57) ABSTRACT

Method of validating mail items by a sender with a view to their handover to a mail distribution service, wherein the mail items are handed over to the mail distribution service by the sender without affixing any post mark, the mail items each being provided with a unique identification number at the manufacturing stage and this number, following capture by the sender, being transmitted to a server together with an amount payable determined by the sender, the confirmation of payment by a debit on the sender's account in the server constituting proof of franking. The invention also relates to a mail item and terminals for the validation and verification of mail.

### TECHNICAL FIELD

The present invention relates to the area of mail processing and more particularly it concerns an entirely novel method and system enabling mail items to be sent without franking.

### PRIOR ART

Since 1840 and the creation of the first postage stamp in Great Britain, the postal authorities of all countries have required that the mail items distributed by their offices be franked (indeed it was originally the recipient who paid the costs of carrying the mail), that is to say they are marked with a franking mark attesting payment by the sender of a duty on the service rendered by the postal authority.

For private individuals and very small enterprises handling little mail, this franking mark essentially comprises one or more postage stamps or an adhesive label of which the tariff varies in particular according to the destination and the weight of the mail item on which the postage stamp(s) or the label are affixed. In the case of larger enterprises, this mark is composed of a postmark printed by franking systems, of the closed type (franking machine) or open type (using a general purpose computer connected to a standard printer), in most cases leased from a provider accredited by the postal authority and in which metering of the postage is carried out by a secure device referred to as an SMD (for Secure Metering Device) or PSD (for Postal Security Device). Also, for enterprises that specialise in sending large quantities of mail, referred to as “routers”, the postal authorities authorise the use, instead and in place of the postmark, of an authorisation code or “permit” number which, in combination with a “manifest” listing, under the terms of the authorisation or the permit, all of the mail items submitted to the postal authority and their individual characteristics, makes it possible, upon receiving the mail items and the associated manifest and verification of the indicated characteristics, to debit the postal account held by the router with the postal authority.

Franking systems of both the closed and open type by and large provide satisfaction. However, to avoid counterfeiting and to facilitate the use of increasingly sophisticated value-added services, postmarks are becoming more and more complex, requiring the sender to print more information in a space that is not extensible, while for the postal authority it is becoming very costly to read and authenticate a mark of such complexity. Moreover, to ensure perfect recognition of the postmark, the latter needs to be of very high quality (high resolution, perfect print head alignment, compensation of ageing) and it is difficult to achieve such a result at high franking throughputs with current thermal or inkjet printing processes.

### DEFINITION AND OBJECT OF THE INVENTION

The present invention, therefore, concerns a highly innovative system and method of processing mail which overcomes the multiple problems posed not only by the printing quality of complex franking marks but also by the ciphering and metering thereof. One object of the invention is to propose a system and a method of processing mail which facilitates a reduction of the printed postal data. Another object of the invention is to propose a system and a method of processing mail that is valid for all categories of users, from the private individual to the router.

These objects are achieved in a method of validating mail items by a sender with a view to their handover to a mail distribution service, wherein the mail items are handed over to the mail distribution service by the sender without affixing any post mark, the mail items each being provided with a unique identification number at the manufacturing stage and this number, following capture by the sender, being transmitted to a server together with an amount payable determined by the sender, the confirmation of payment by a debit on the sender's account in the server constituting proof of franking.

Thus, debiting of the sender's account in a remote server replaces conventional franking and elimination of the postmark alleviates all of the problems posed by the processing thereof such as ciphering or metering of franking operations at the sender's end. The conventional secure metering device (PSD) is thus eliminated, as are the conventional means of printing the postmark.

To put into effect the abovementioned method of validating mail, it is necessary to use a specific mail item including a unique identification number incorporated during its manufacture and intended, following capture by the sender, to be transmitted to a server together with an amount payable for sending the mail item.

It is also necessary to replace the conventional franking machine by a validation terminal for the validation of mail items by a sender with a view to the handover thereof to a receiving office of a mail distribution service, characterised in that it includes digital capture means to read a unique identification number carried by the mail item, means of determining an amount payable for this mail item, means of transmitting to a remote server said amount payable and said unique identification number associated with the mail item to be sent, and means of receiving from the remote server a confirmation of payment constituting proof of validation of the mail item.

Preferably, said digital capture means are additionally capable of reading the recipient's address, the mail class and/or the requested service(s) printed on the mail item during the manufacture thereof.

Advantageously, the terminal can additionally include means of automatically determining the format and/or weight of the mail item or input means to enable the sender to enter via the terminal one or more of the following details: the format and/or the weight of the mail item, the mail class, the requested service or services which said transmission means are additionally capable of transmitting to the remote server.

Depending on the embodiment envisaged, said digital capture means can include a scanner or a barcode reader or an RFID read/write means when said unique identification number is recorded in an RFID tag carried by the mail item.

Preferably, said digital capture means are detachable to facilitate the reading of recipient addresses marked on thick envelopes or packets that cannot be passed through said terminal.

The invention also concerns the method of validating mail items by a sender with a view to the handover thereof to a receiving office of a mail distribution service, characterised in that it includes the following steps:

obtaining a unique identification number carried by the mail item,

determining an amount payable for sending the mail item to its recipient,

transmitting to a server the amount payable associated with the unique identification number of the mail item to be sent,

debiting the amount payable from the sender's account managed at the server,

receiving a confirmation of payment originating from the server constituting proof of validation of the mail item and handing over the mail item to a receiving office of a mail distribution service.

Depending on the embodiment envisaged, said unique identification number is retrieved either from an identification code printed on the mail item in the form of a machine-readable string of alphanumeric characters, or a barcode that is advantageously two-dimensional, or from an RFID tag carried by the mail item, or from a characteristic paper imprint unique to the mail item.

Preferably, there is additionally provided a step wherein the sender obtains the recipient's address printed by the sender on the mail item so as to determine a geographical area of destination, the mail class and/or the requested service or services.

Advantageously, the mail class and/or the requested service or services printed on the mail item during its manufacture are read by the sender. However, the mail class and/or the requested service or services can also be entered by the sender.

There can be additionally provided a step wherein the sender determines the format and/or weight of the mail item, determination of the format of the mail item being able to be effected by reading the unique identification number.

Said mail distribution service is a postal authority or a private carrier.

The invention also concerns the method of verifying mail items at a receiving office of a mail distribution service, characterised in that it includes the following steps:

obtaining, by digital capture means, the recipient's address and a unique identification number carried by each mail item received,

determining, by format and/or weight determination means, the format and/or weight of each mail item,

calculating, by the processing means, the amount payable in relation to the destination, format and/or weight thus obtained,

comparing, by the processing means, the calculated amount with an amount payable validated by the sender and retrieved from a server based on a unique identification number, and

sorting, by sorting means, of each mail item according to its destination.

Depending on the embodiment envisaged, said unique identification number is retrieved, by processing means, either from an identification code printed on the mail item in the form of a machine-readable string of alphanumeric characters, or a barcode that is advantageously two-dimensional, or from an RFID tag carried by the mail item, or from a characteristic paper imprint unique to the mail item.

Preferably, if the calculated amount is greater than an amount validated by the sender and retrieved from the server, a calculation is performed by processing means, at a step before the mail item is sorted, to determine the balance of the amount plus a fine that the recipient will be required to remit so as to secure the surrender of the mail item by an agent of the mail distribution service.

There can be additionally provided a step wherein the mail class and/or the requested service or services is obtained.

### BRIEF DESCRIPTION OF THE DRAWINGS

Other characteristics and advantages of the present invention will become more clearly apparent from the following description, provided for information and non limitative of the invention, in reference to the attached drawings, in which:

FIG. 1 shows an example architecture of a mail processing system according to the invention,

FIG. 2 illustrates a variant of the system from the sender's viewpoint,

FIGS. 3A and 3B are block diagrams illustrating the different steps of the validation and verification method implemented in the system in FIG. 1, and

FIGS. 4A to 4D show several examples of mail items used in the system in FIG. 1.

### DETAILED DESCRIPTION OF A PREFERRED EMBODIMENT

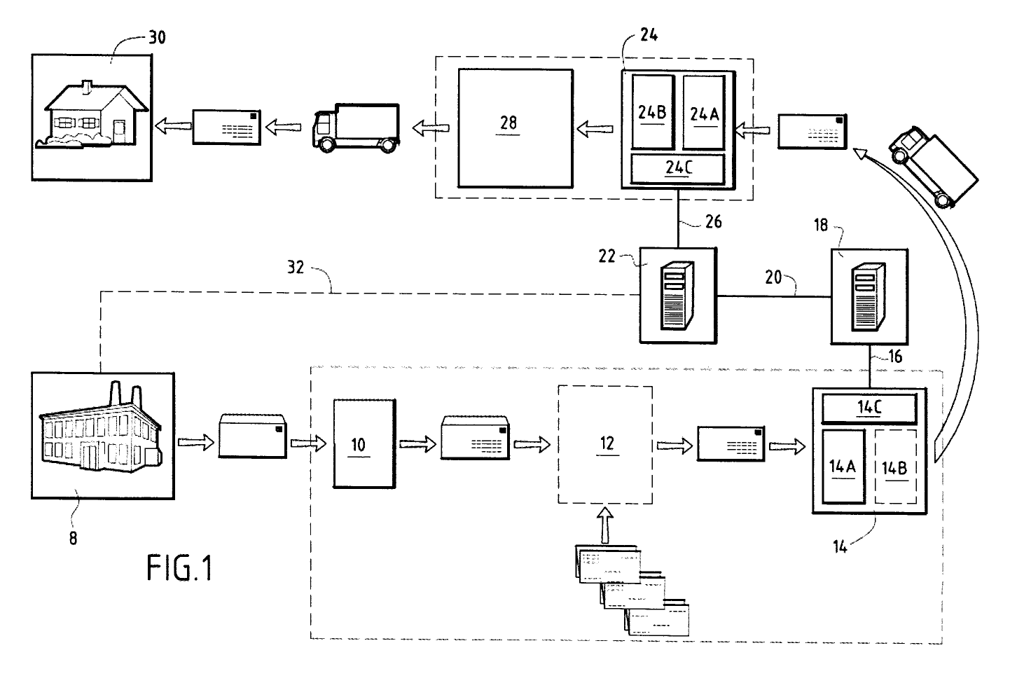

FIG. 1 is a schematic illustration of the architecture of a system intended to process mail items according to the invention. The expression mail item should be understood to mean both an envelope (of any format with or without window) and a label intended to be affixed on a thick envelope or a packet of any shape.

This mail processing system is based on an entirely novel principle of sending mail items without first franking these items. In other words, the mail items to be sent which will be caused to pass through a mail distribution network, for example that of the postal authority or a private carrier, will not bear any postmark having monetary value, whether it be a postage stamp, a postmark or a permit number, affixed by the senders of these items.

Thus, according to the invention, the mail items to be sent on each of which the recipient's address has been pre-printed by a standard printer 10 and which have been prepared for mailing either manually or in a folding and insertion machine 12 by the sender, include at the outset, i.e. before processing by the sender and therefore on completion of their manufacture by a manufacturer/printer 8, a unique identification number which will be used, once validated by the sender, i.e. following capture by the sender, transmission to a server together with an amount payable determined by the sender and confirmation of payment by debiting the sender's account at the server, to track the mail item on which it is affixed through the mail distribution network and to verify payment of the postal service or services attached to the item. This validation of the unique identification number is performed by passing the mail item bearing details of its recipient and the unique identification number through a validation terminal for these mail items 14 linked via a dedicated line 16 to a computer server 18 operated by the provider of the terminal. Of course, the dedicated link 16 can be replaced by a connection via an external communications network, for example the Internet. A dedicated line 20 links the provider's server with a postal authority server 22 (however, a link over the Internet can of course also be envisaged), which server can also be connected via a link 32 to the manufacturer 8 of the mail items. It will be noted, however, that in certain operating conditions the postal authority server 22 can be connected directly to the terminal and therefore can be used instead and in place of the above to perform all of the operations relating to the method of the invention as will be described further.

After passing through the validation terminal 14, the mail items will be deposited at a receiving office of the mail distribution service, for example the postal authority, where they will be processed and in particular sorted with a view to being forwarded to their respective recipients. To this end, they will first pass through a verification terminal 24 including, like the validation terminal 14, digital capture means 24A and means 24B of determining the format and/or weight of each mail item fed into the terminal. This terminal 24 is linked to the remote server of the postal authority 22 by a dedicated line 26 or via a communications network, for example the Internet. Once each of the mail items has been verified by processing means 24C, they can join the conventional processing stream 28 for sorting by destination and forwarding to the recipient 30.

The provider's computer server 18 is a computer server including conventional software means enabling on the one hand the management of customer accounts and statistical control, for example via a customer database, and on the other hand updating in the validation terminal of the tariff tables and postal services offered by the mail distribution service. However, this server does not provide a credit reloading function for the validation terminal because this terminal does not handle monetary values and does not therefore include secure postage metering means (PSD).

The mail validation terminal and mail verification terminal are machines that can have a mechanical design similar to that of a conventional closed type franking machine, i.e. conventionally including: means of feeding mail items, means of selecting one of these items, and means of conveying the mail item through the terminal. However, according to the invention, they each also necessarily include digital capture means 14A, 24A and, in the case of the verification terminal, means 24B of determining the format and/or weight of the mail item selected by the selection means. These means 14B can be omitted from the validation terminal the keypad of which permits direct entry of the weight class provided the latter is available by a simple calculation based on knowing the weight of the documents contained in the mail item and of the article itself.

The digital capture means which are preferably disposed after the means of selecting individual mail items and preferably above the means 14B, 24B of determining the format and/or weight, when the terminal is provided therewith, are formed by a scanner and associated software recognition means. Depending on the embodiment envisaged, the scanner can comprise a simple barcode reader or an OCR reader.

Advantageously, the digital capture means can be removable to facilitate reading of labels intended to be affixed to thick envelopes (which therefore cannot be fed into the terminal) or packets. The connection of these capture means to the terminal can then be of the wired or wireless type.

These terminals, of course, include means of interfacing (of the modem type for example) with the dedicated line 16, 26, means of interfacing with the user, of the screen and keyboard type for example, and processing means 14C, 24C (more particularly with memory and microprocessor) for managing and controlling the terminal, in particular its transmission means.

However, in accordance with the principle of the invention mentioned above, the validation terminal, which is not a machine that delivers a franking mark, does not include the conventional printing means (mechanical, inkjet or thermal) to affix the franking mark (postmark or any other inscription such as an authorisation code or a permit number compliant with the postal specifications) on the mail item and the secure postage metering means (PSD) which are associated therewith in particular for the processing of franking values and ciphering of the postmark.

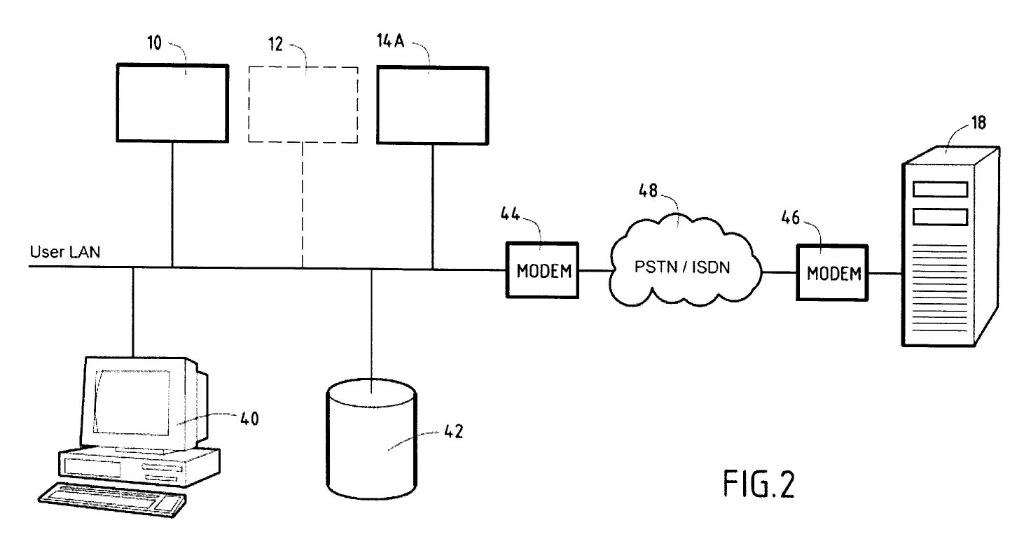

FIG. 2 illustrates a variant of the invention, wherein the sender of mail items, a private individual or a small enterprise for example, works in an open environment with one or more general purpose computers 40 organised around a local area network (user LAN) and equipped with common resources, in particular a database 42. To this local area network are connected the printing means 10 making possible both the printing of documents and printing of the recipient's address, optionally the folding/insertion means 12 and the digital capture means 14A necessary to validate the mail items. In this open environment, the presence of means of determining the format and/or weight is not indispensable as this information can be determined automatically by the computer 40 which holds full details of the contents of the mail items. A modem 44 linked to the local area network can provide a remote connection with a modem 46 associated with the provider's server 18 via a communications network 48, for example the public switched telephone network or the Internet.

The database 42 is a mailing database populated during the creation of the documents to be sent by the computer(s) on which they were prepared. In a conventional manner it can contain, for each article of mail to be sent referenced by a sequence number, at least the following fields: the reference of the document contained in the mail item, the reference(s) of any inserts to be included with the document, and the recipient's address. Without this list being exhaustive, other information such as the document creation date, the name or personal number of the person who created the document or the department involved in the mailing, the desired postal service, or an additional description field can be added to the database. Searching and indexing of this database can be performed on each of these fields.

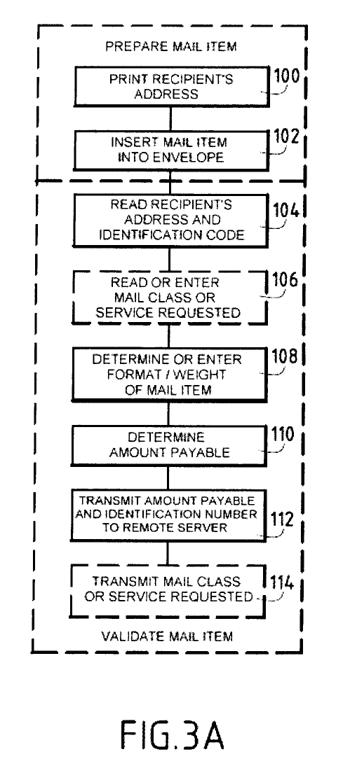

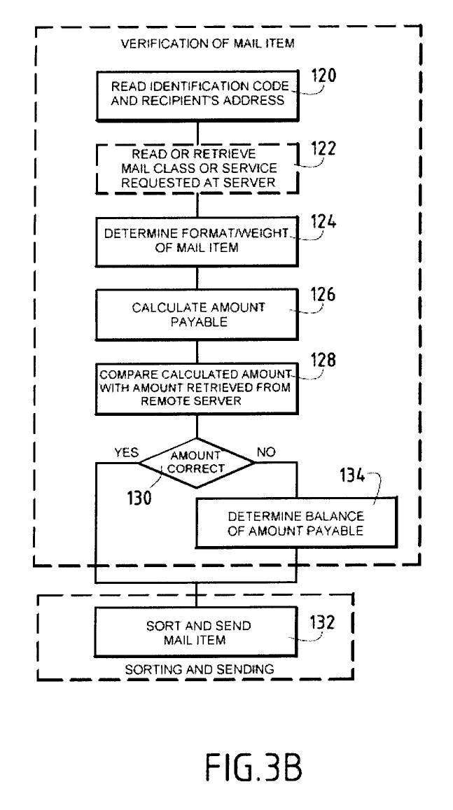

The method implemented in the mail processing system in FIG. 1 from validation by the sender through to verification by the postal authority will now be explained in reference to the block diagrams in FIGS. 3A and 3B.

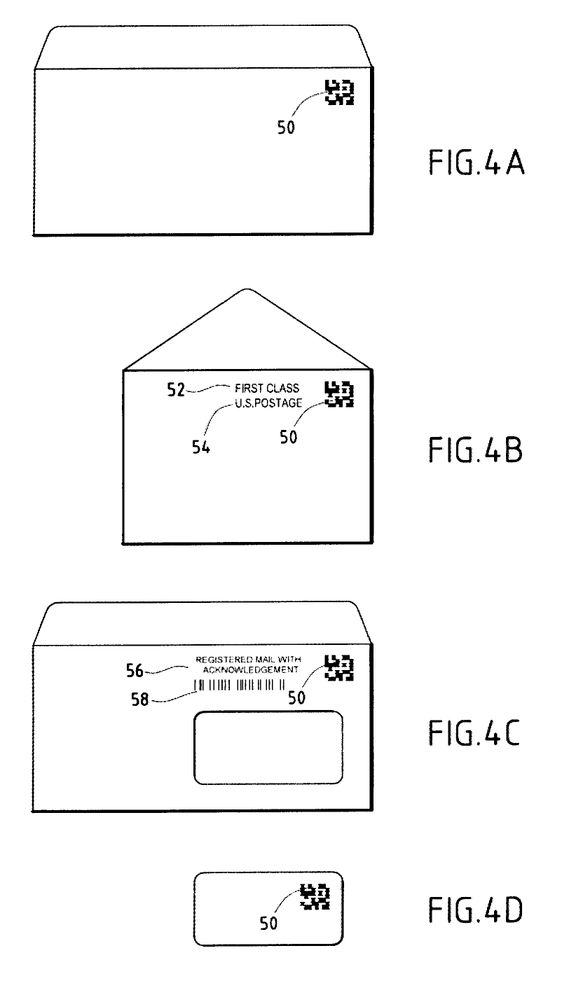

Its implementation calls for the use of particular mail items supplied by a paper goods manufacturer. These mail items, envelopes as depicted in FIGS. 4A to 4C or labels depicted in FIG. 4D, are therefore not blank but each includes a unique number incorporated into an identification code 50 pre-printed by a printing process preferably of the offset or laser type given the quality and durability of printing obtained by such a process compared with inkjet or heat transfer printing processes commonly employed in conventional franking machines. In an alternative embodiment, the mail items can also carry an indication of the mail class 52 and an indication of the postal authority 54 which authorised the manufacture as depicted in FIG. 4B. In another variant, these mail items can also include the indication of a service 56 attached to the mail item, for example “registered with acknowledgement”. All of these indications, which are, of course, readable by a scanner, can be duplicated in a barcode 58. In the latter case, a simple barcode reader can perform the digital capture function.

Preferably, this unique identification number is incorporated into a code with a high capacity for coding digital or alphanumeric data and error correction, such as two-dimensional barcodes of which the best known are: Aztec code, Codablock, Code one, Code 16K, Code 49, data matrix, PDF 417, QR Code, or Supercode. The high coding capacity of this type of code (including up to 4296 characters at the higher end) thus makes it possible for the code to include not only the identification number ensuring that no two mail items can have the same number, but also other information relating to the mail item, such as a format reference in the case of an envelope having a specific format such as that depicted in FIG. 4B, or such as those provided by the EPC (Electronic Product Code) standard developed by the standardisation organisation of the same name and including in particular the country of origin, manufacturer number, etc. In this case, the unique identification number is advantageously a sequential number drawn from a range of numbers allocated by that organisation. However, it is of course also possible to envisage a series of numbers issued by the postal authority server 22 via the link 32 or a non-reusable random number.

Referring to FIGS. 3A and 3B, the mail items carrying the identification code 50 together with any indications of the mail class 52 or requested postal service 56 which, in previous steps, will have been marked with the recipient's address (step 100), this address possibly being printed by the printing means 10 on the envelope or label or directly on the document to be placed in the envelope in the case of a window envelope, and will have been inserted into the envelope (step 102) either manually or by the folding/insertion machine 12, can then be fed into the validation terminal 14 to undergo the validation process of the invention. This process includes, at a step 104, reading by the digital capture means 14A of the recipient's address (to retrieve the geographical area of the destination of the mail) and the identification code marked on the mail item together with any indications of the mail class or requested services (step 106). Failing such indications, the validation terminal acquires the data relating to the mail class or service(s) requested by the sender entered via the terminal keyboard or received via the sender's local area network if any (step 106). It can also include, at a step 108, an automatic determination of the format and/or weight by the means 14B of the terminal. When this automatic determination is not possible (in the case of a label for example), an entry via the terminal keyboard of the weight class can cater for this eventuality (step 108).

Based on this information: geographical area of destination, weight and optionally indication of the mail class or service(s), the processing means 14C of the validation terminal will determine, at a step 110, the amount payable by the sender and this amount associated with the unique identification number of the mail item retrieved from the identification code by the means 14A and optionally associated with the mail class or requested service(s), where these are present on the mail item or entered via the keyboard, is transmitted in a secure manner at a step 112 to the remote server of the validation terminal provider so that the sender's account can be debited. These details will then be forwarded at a last step 114 to the server of the mail distribution service which will then be credited at most by the abovementioned amount. This transmission can be performed for each batch of mail, but it is preferable that it is performed only once a day, for example before the mail items are handed over to the mail distribution service, or at the end of the day. In this case, the validation terminal will advantageously include a tracking database created when the terminal was put into service or when a mail item was first passed through the terminal and which will be populated as each successive mail item passes through the validation terminal. This database can reside in the storage means of the processing means of the validation terminal or independently therefrom outside the terminal, for example at the level of the common resources of the local area network as the case may be. It can comprise a large number of fields including, of course, the pre-entered data, amount payable, unique identification number and requested service, but also other data such as the reference number of the validation terminal, the name and number of the receiving office of the postal authority at which the mail will be deposited, etc. All of these details can, of course, also be transmitted to the remote server if necessary.

In the case of an open environment of the type in FIG. 2, it will be noted that this tracking database can advantageously include the sequence number which serves to tie the mail item to its content held in the prepared mailing database 42.

When a mail item is received at a receiving office of the mail distribution service, for example the postal authority, it is passed through the verification terminal 24 where in a first step 120 the digital capture means 24A automatically reads the identification code, the recipient's address and optionally the indications of mail class or requested service(s) if any (step 122) and, at a next step 124, the format and/or weight of the mail item is determined by the means 24B. Based on this information, a calculation is made by the processing means 24C, at a further step 126, of the amount payable which can then be matched (compared) with that present in the server of the mail distribution service and received from the provider's server. The logistics system of the mail distribution service can then proceed to sort and process the mail item according to its destination and the services requested by the sender (step 132 following a Yes response to the test at step 130) and optionally return to the providers' server and/or make accessible to the sender, via suitable means of input such as input via an Internet site of the mail distribution service, various tracking information relating to the mail item processed. It will simply be noted that if the amount payable calculated by the mail distribution service is found to be greater than that available at its server (No response to the test at step 130), the corresponding mail item will still be delivered to its recipient subject to remittance of an increased payment, the processing means thus calculating the balance of the amount plus a fine to be remitted by the recipient so that the mail item can be surrendered thereto by an agent of the mail distribution service (step 134). The same will apply if the identification number read at the verification terminal is not found in the server, thus signifying that the sender has not made any payment.

The method according to the invention is particularly innovative and presents numerous advantages compared with the franking methods of the prior art. Thus, from the sender's viewpoint, by virtue of the absence of franking, the processing rate of mail items is no longer limited by printing performance and can therefore be very high, typically higher than 20,000 envelopes per hour, which is beyond the capability of the most efficient franking machines, or higher in the case of processing in uniform batches. Furthermore, the absence of secure postage metering means (up and down counters) at the validation terminal eliminates all current frauds that involve blocking or modifying these counters to allow additional frankings to be made. Similarly, at the receiving offices of the mail distribution service, verification can now be performed on each mail item rather than by sampling, as it is no longer necessary to undertake lengthy deciphering of a complex franking mark. Counterfeiting by reproduction is also no longer to be feared in that, following a first verification, the unique identification number cannot be recognised a second time without drawing the attention of the mail distribution service. Furthermore, in the absence of validation (non payment by the sender), delivery of the mail item to its recipient may only be effected against payment plus a fine thereby avoiding any loss of revenue to the postal authority. Also, from the viewpoint of both the sender and the offices of the mail distribution service, the simplicity of the validation and verification processes makes it possible to achieve a notable reduction in mail processing costs.

It will be noted that while the preceding description is presented essentially with reference to a 2D identification code printed on the mail item, it is clear that a code formed by a machine-readable string of alphanumeric characters can also be envisaged. Similarly, it can also be envisaged instead and in place of the printing operation to provide the mail item with an RFID tag including the unique identification number, the digital capture means then being advantageously formed by an RFID reading/writing means. More radically, but still, however, remaining within the scope of the invention, it can be envisaged to use the technology developed by the US company INGENIA, which is a technology that does away with all printing of codes on the mail item, the unique identification number then being retrieved by suitable digital capture means directly from a characteristic paper imprint unique to the mail item and constituting a sort of digital fingerprint.

1. Method of validating mail items by a sender with a view to their handover to a mail distribution service, wherein the mail items are handed over to the mail distribution service by the sender without affixing any post mark, the mail items each being provided with a unique identification number at the manufacturing stage and this number, following capture by the sender, being transmitted to a server together with an amount payable determined by the sender, the confirmation of payment by a debit on the sender's account in the server constituting proof of franking.

2. Mail item for putting into effect the mail validation method according to claim 1 including a unique identification number incorporated during its manufacture and intended, following capture by the sender, to be transmitted to a server together with an amount payable for sending the mail item.

3. Method of validating mail items by a sender with a view to the handover thereof to a receiving office of a mail distribution service, comprising the following steps:
obtaining a unique identification number carried by the mail item,
determining an amount payable for sending the mail item to its recipient,
transmitting to a server the amount payable associated with the unique identification number of the mail item to be sent,
debiting the amount payable from the sender's account managed at the server,
receiving a confirmation of payment originating from the server constituting proof of validation of the mail item and handing over the mail item to a receiving office of a mail distribution service.

4. Method according to claim 1, wherein said unique identification number is retrieved from an identification code printed on the mail item in the form of a machine-readable string of alphanumeric characters or a barcode that is advantageously two-dimensional.

5. Method according to claim 1 wherein said unique identification number is retrieved from an RFID tag carried by the mail item.

6. Method according to claim 1, wherein said unique identification number is retrieved from a characteristic paper imprint unique to the mail item.

7. Method according to claim 3, wherein it additionally includes a step wherein the sender obtains the recipient's address printed by the sender on the mail item so as to determine a geographical area of destination.

8. Method according to claim 3, wherein it additionally includes a step wherein the sender obtains the mail class and/or the requested service or services.

9. Method according to claim 8, wherein the mail class and/or the requested service or services printed on the mail item during its manufacture are read by the sender.

10. Method according to claim 8, wherein the mail class and/or the requested service or services are entered by the sender.

11. Method according to claim 3, wherein it additionally includes a step wherein the sender determines the format and/or weight of the mail item.

12. Method according to claim 10, wherein the determination of the format of the mail item is effected by reading the unique identification number.

13. Method of verifying mail items at a receiving office of a mail distribution service, comprising the following steps:
obtaining, by digital capture means (24A), the recipient's address and a unique identification number carried by each mail item received,
determining, by format and/or weight determination means (24B), the format and/or weight of each mail item,
calculating, by the processing means (24C), the amount payable in relation to the destination, format and/or weight thus obtained,
comparing, by the processing means (24C), the calculated amount with an amount payable validated by the sender and retrieved from a server based on a unique identification number, and
sorting, by sorting means (26), of each mail item according to its destination.

14. Method according to claim 13, wherein said unique identification number is retrieved by processing means (24C) from an identification code printed on the mail item in the form of a machine-readable string of alphanumeric characters or a barcode that is advantageously two-dimensional.

15. Method according to claim 13, wherein said unique identification number is retrieved, by processing means (24C), from an RFID tag carried by the mail item.

16. Method according to claim 13, wherein said unique identification number is retrieved, by processing means (24C), from a characteristic paper imprint unique to the mail item.

17. Method according to claim 13, wherein the calculated amount is greater than an amount validated by the sender and retrieved from the server, a calculation is performed by processing means (24C), at a step before the mail item is sorted, to determine the balance of the amount plus a fine that the recipient will be required to remit so as to secure the surrender of the mail item by an agent of the mail distribution service.

18. Method according to claim 13, wherein it additionally includes a step wherein the mail class and/or the requested service or services is/are obtained.

19. Mail validation terminal (14) for the validation of mail items by a sender with a view to their handover to a receiving office of a mail distribution service, wherein it includes digital capture means (14A) to read a unique identification number carried by the mail item, means (14C) of determining an amount payable for this mail item, means (14C) of transmitting to a remote server (18) said amount payable and said unique identification number associated with the mail item to be sent, and means (14C) of receiving from the remote server a confirmation of payment constituting proof of validation of the mail item.

20. Mail validation terminal according to claim 19, wherein said digital capture means are additionally capable of reading the recipient's address.

21. Mail validation terminal according to claim 19, wherein said digital capture means are additionally capable of reading the mail class and/or the requested service or services printed on the mail item during the manufacture thereof.

22. Mail validation terminal according to claim 19, wherein it additionally includes means (14B) of automatically determining the format and/or weight of the mail item.

23. Mail validation terminal according to claim 19, wherein it additionally includes input means to enable the sender to enter via the terminal one or more of the following details: the format and/or the weight of the mail item, the mail class, the requested service or services.

24. Mail validation terminal according to claim 19, wherein said transmission means are additionally capable of transmitting to the remote server one or more of the following details: the format and/or the weight of the mail item, the mail class, the requested service or services.

25. Mail validation terminal according to claim 19, wherein said transmission means are additionally capable of transmitting to the remote server one or more of the following details: the format and/or the weight of the mail item, the mail class, the requested service or services.

26. Mail validation terminal according to any one of claim 19, wherein said digital capture means include an RFID reading/writing means when said unique identification number is recorded in an RFID tag carried by the mail item.

27. Mail validation terminal according to claim 19, wherein said digital capture means are removable to permit the reading of recipient addresses marked on thick envelopes or packets that cannot be passed through said terminal.
